(19) United States
(12) Patent Application Publication
(10) Pub. No.: US 2011/0167741 A1
(43) Pub. Date: Jul. 14, 2011

(54) METHODS AND SYSTEMS FOR RETROFITTING GLASS OR INSULATED GLASS UNITS OF EXISTING CURTAIN WALL SYSTEMS FOR IMPROVED THERMAL PERFORMANCE

(76) Inventors: Kevin Surace, Sunnyvale, CA (US); Daniel E. Boss, Lake Villa, IL (US); Kent Whiting, Campbell, CA (US); Robert Hart, San Francisco, CA (US)

(21) Appl. No.: 12/859,180

(22) Filed: Aug. 18, 2010

Related U.S. Application Data
(60) Provisional application No. 61/234,998, filed on Aug. 18, 2009.

(51) Int. Cl. E06B 1/04; E04C 2/38; E06B 1/36

(52) U.S. Cl. 52/204.1; 52/588.1; 52/656.9

(57) ABSTRACT

A glass retrofitting system with an adaptor is configured to mount a glass member to a wall or window frame. The glass member may be an upgraded insulated glass unit to replace an existing glass in a wall or window frame. The adaptor may include a mating portion (or an anchor member) which fits into an existing glazing pocket of the existing window or wall frame. The width of the existing glazing pocket may not be wide enough to accommodate the upgraded insulated glass unit. Thus, the adaptor may form a new glazing pocket suitable to hold the upgraded insulated glass unit, and the insulated glass unit may be mounted or installed into the new glazing pocket formed by the adaptor. The adaptor may be formed of low thermal conductivity material, or of a single piece or a plurality of pieces.

### CROSS-REFERENCE

This application claims the benefit of U.S. Provisional Application No. 61/234,998 filed Aug. 18, 2009, which application is incorporated herein by reference in its entirety.

### BACKGROUND OF THE INVENTION

Heat loss from buildings in cold environments (e.g., heat loss during the winter) and heat gain by buildings in warm environments (e.g., heat gain during the summer) through windows may lead to increases in the demand for energy. Keeping a building warm during the winter may lead to high energy costs, and thermal losses through current windows may lead to increased energy costs. Similarly, heat gain through current windows during the summer may lead to increased energy costs, as additional energy would have to be used to remove this heat. While there are several technologies available today which may be used to achieve high center of glass insulation and “warm edge” spacers, there are no standard options available to apply these solutions to an existing glass curtain wall frame. Specifically, existing windows with poor energy performance are thinner, with fewer material layers than their thicker, higher performance counterparts. A base performance glass lite may have a thermal conductance (u-factor) of 0.4 to 1.0 whereas a high performance multilayer system may have a thermal conductance of 0.1 to 0.3 The prior, thermally poor unit may consist of or a maximum of two glass layers with a assembly thickness of ¼ inch to ⅞ inches. The latter, high performance glass units consist of two, three, or more transparent layers (glass, films, or a combination of both), and have an assembly depth of about ⅞ inches up to 2 inches.

The installation of such an improved window with more layers and greater thickness may lead to high installation costs if the improved glazing unit is not compatible with the existing window frame. The cost of retrofitting the glazing into an existing curtain wall may be up to 20 times the material costs and may lead to unacceptable payback periods. In addition to high installation costs, the installation of an improved window may lead to home or workforce disruption if a significant amount of work is required.

There is thus a need in the art for technologies allowing for the installation of improved windows (such as improved IGUs) in existing window or wall frames, such as curtain wall frames not originally designed to accept them.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention can be further explained by reference to the following detailed description and accompanying drawings that sets forth illustrative embodiments of the invention.

FIG. 1 is a face view of an adaptor, glass structure and window frame, in accordance with an embodiment of the invention;

FIG. 2 is a cross-sectional side view of an all-metal adaptor, in accordance with an embodiment of the invention;

FIG. 3 is a cross-sectional side view of a thermally broken adaptor with metal legs and a composite/plastic center break, in accordance with an embodiment of the invention;

FIG. 4 is a cross-sectional side view of an all composite (fiber reinforced polyester or polyurethane) adaptor, in accordance with an embodiment of the invention;

FIG. 5 is a cross-sectional side view of a symmetric adaptor, in accordance with an embodiment of the invention;

FIG. 6 is a cross-sectional side view of a thermally broken pressure plate, in accordance with an embodiment of the invention; and

FIG. 7 is a cross-sectional side view of a composite (fiber reinforced polyester or polyurethane) pressure plate, in accordance with an embodiment of the invention.

### DETAILED DESCRIPTION OF THE INVENTION

Glass curtain wall systems previously installed in a variety of commercial and institutional buildings may use a single pane of glass or a simple double (or multiple) pane insulated glass unit (IGU). The thermal performance of the assembly currently used in these systems, however, may be poor. A base performance glass lite may have a thermal conductance (u-factor) of 0.4 to 1.0 compared to opaque wall sections that may have u-factors of 0.15 to 0.05. Also, the existing glass packages may have inadequate or missing low emissivity (low-e) solar control layers. Their omission may result in unwanted summer solar gain that also may increase the energy demands of the building. If higher performing IGUs could be installed, the energy needed to heat and cool these buildings could be reduced. However, the installed curtain wall frames of buildings may not be able accommodate the wider, higher performing IGUs. Instead of replacing the curtain wall frame so that a wider IGU may be used, the existing curtain wall framing system may be kept in place, and instead, embodiments of the present invention may provide solutions for replacing or modifying the glass system for higher thermal performance.

In one embodiment, an adaptor bracket may be used. The adaptor bracket may have a “Y” shape, or similar structure, as described herein. The broad section of the “Y” may accommodate a wider high performance IGU (or an IGU of a different size) while the root of the “Y” may fit into the glazing pocket space of the current curtain wall frame. The adaptor bracket could be formed from solid aluminum, two pieces of aluminum with a thermal break between the exterior and interior sections, or a non-metallic (composite) structure. It can be appreciated that various constructions are contemplated for the adaptor bracket.

In another embodiment, a pressure plate may be utilized to hold a wider high performance IGU (or an IGU of a different size) in place. The pressure plate may be a “Z”, “L”, or other shape that can be attached to the existing curtain wall frame, exert compressive force on the interior surface of the high performance IGU, and pull it against the curtain wall system.

In another embodiment, an asymmetric high performance IGU may be installed using embodiments described herein. An asymmetric high performance IGU may include an exterior glass pane that is wider than the existing spacer, film, and/or interior glass pane, thus making it difficult and costly to install using currently available methods. When using embodiments of the present invention as described herein, the asymmetric high performance IGU may be installed such that the exterior glass pane may fit into the existing glazing pocket of the current curtain wall frame.

In accordance with various embodiments of the invention, to retrofit or materially improve a current piece of glass installed in a curtain wall frame, a spacer, film or glass pane assembly described above could be added to a currently installed glass pane of the curtain wall. The installation could be done with the curtain wall glass remaining installed, or the current wall glass may be removed and modified on site before reinstallation.

Since a high performance IGU may have a higher weight than the existing curtain wall glass, ancillary brackets or supports may be also be utilized to relieve some of the structural stress on the curtain wall frame. Thus, in accordance with various embodiments of the invention, thicker, and/or higher R-value or lower u-factor IGUs may be placed into current curtain wall frame systems of existing buildings, without replacing the entire curtain wall frame. Thus, the curtain wall metal structure already installed in a building may not need to be replaced before the end of its useful life, in order for higher performance IGUs to be implemented.

Retrofit systems of embodiments of the invention may advantageously reduce, if not eliminate, the need to completely replace an existing un-insulated or non-thermally broken glass curtain wall system in pursuit of increasing the thermal efficiency of existing systems. By increasing the efficiency of an existing system instead of demolishing and installing a new system, a significant decrease in material usage, labor, and capital costs can be achieved.

Retrofit systems of embodiments of the invention may strike an optimum balance between thermal performance, structural performance, air and moisture management and manufacturability to find the lowest cost solution and highest financial payback due to energy savings over the expected lifetime of the system.

By increasing the efficiency of an existing system, for example by 20% or more, instead of redesigning and installing a new system, systems of embodiments of the invention may provide a significant decrease in material usage, labor, and capital costs. A reduction in capital costs associated with high efficiency curtain wall systems can enable more widespread use. Retrofit systems of embodiments of the invention provide retrofit frame adaptors that may be quickly mounted onto or into an existing curtain wall frame system and allow for efficient replacement of or integration with an existing glass system.

Retrofit adaptors of embodiments of the invention may be widely compatible with curtain wall systems and not require full demolition and redesign of the base curtain wall system for installation. Retrofit systems (including adaptors) of embodiments may be assembled from component materials, ensuring high thermal resistance. This advantageously reduces costs associated with retrofit labor and materials.

In embodiments of the invention, a retrofit frame adaptor for an insulated glass unit (“IGU”) is provided that may mount onto (or into) an existing curtain wall frame system and integrate with an existing glass. Such a system may reduce installation costs. Additionally, retrofit systems of embodiments may be seamlessly installed, which reduces building occupant disruption during installation.

Retrofit systems (including retrofit adaptors) of embodiments of the invention may be formed of various materials, such as aluminum, thermally broken aluminum, fiberglass (e.g., pultruded fiberglass), reinforced polyester and pultruded fiberglass reinforced polyurethane.

In various embodiments of the invention, retrofit systems may be formed of fiberglass. Fiberglass may perform well in humidity extremes and hot and cold environments. Fiberglass may exhibit high condensation resistance, which helps keep humidity within a proper range, limiting the growth of molds and mildew. Fiberglass may also have a very low coefficient of thermal expansion and contraction (CTE), comparable to that of glass. As a result, a fiberglass window may experience less stress between the IGU and frame while maintaining the structural integrity required for a commercial high rise application.

In an aspect of the invention, an adaptor for an insulated glass unit (IGU) comprises a pair of retaining members for securing a glass structure of the IGU and a mating (or anchoring) portion that provides mounting for the IGU within the existing curtain wall structure.

In various embodiments of the invention, a glass retrofitting system comprises an adaptor configured to mount a glass member to a wall or window frame, the glass member having a first surface and a second surface. In various embodiments of the invention, the adaptor comprises a first flange and a second flange. A first portion of the first flange is configured to align with the first surface, and a second portion of the first flange is configured to mount the glass member to the wall or window frame. A first portion of the second flange is configured to align with the second surface, and a second portion of the second flange is configured to mount the glass member to the wall or window frame. In an embodiment, the distance between the first portion of the first flange and the first portion of the second flange (new glazing pocket) is greater than the distance between the second portion of the first flange and the second portion of the second flange (existing glazing pocket). It will be appreciated that a flange, as used herein, may also refer to an arm, leg, housing or other similar structure or member.

Reference will now be made to the figures, wherein like numerals refer to like parts throughout. It will be appreciated that the figures are not necessarily drawn to scale.

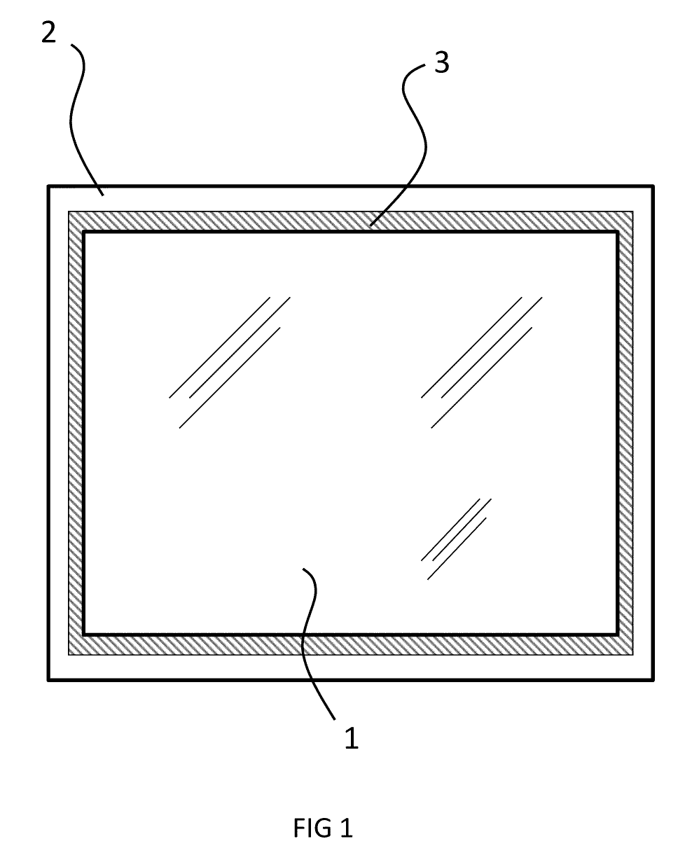

FIG. 1 illustrates a face view of an adaptor 3 mating a glass structure 1 (e.g., IGU) to a window or wall frame 2, in accordance with an embodiment of the invention. The adaptor 3 mounts the glass structure 1 to the window or wall frame 2. In the illustrated embodiment, the adaptor 3 circumscribes the glass structure 1. Alternatively, the adaptor 3 may be in contact with a portion of the glass structure 1. For instance, the adaptor 3 may be in contact with the left and right sides of the glass structure 1. In an embodiment, the adaptor 3 comprises a pair of retaining members for securing the glass structure 1 and a mating (or anchor) portion that provides mounting for the glass structure 1.

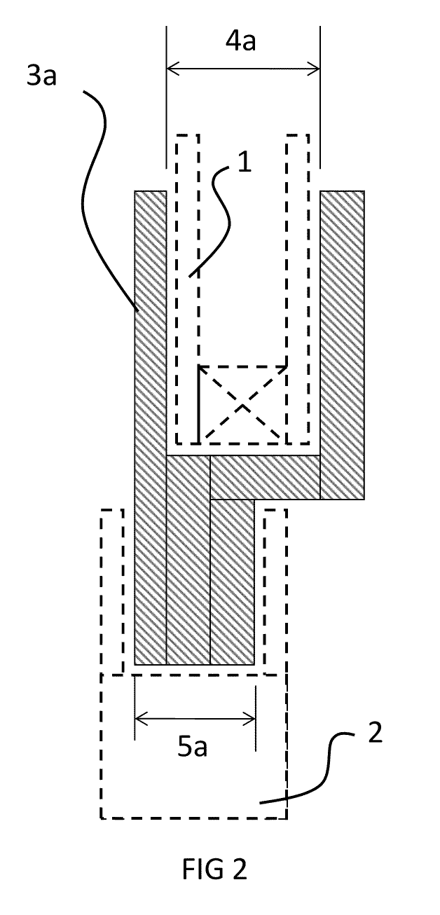

With reference to FIG. 2, an all-metal adaptor is shown, in accordance with an embodiment of the invention. The all-metal adaptor 3a may be configured to mount (or attach) a glass member (or structure) 1 to a window or wall frame 2. The glass member 1 may be an IGU, such as a double or triple pane IGU. In an embodiment, the distance between opposing flanges 4a, of the adaptor 3a, may be greater than the distance 5a, provided by the wall frame 2. Distances 4a and 5b are termed the new and existing glazing pockets, respectively. The opposing flanges of the adaptor 3a may be configured to form a seal with the glass member 1 with either a preformed gasket or a wet glazing material such as silicone. In an embodiment, the opposing flanges may be configured to form a seal with the glass member 1 with the aid of a sealing member (not shown). Each flange of the adaptor 3a may be formed of a single piece or a plurality of pieces.

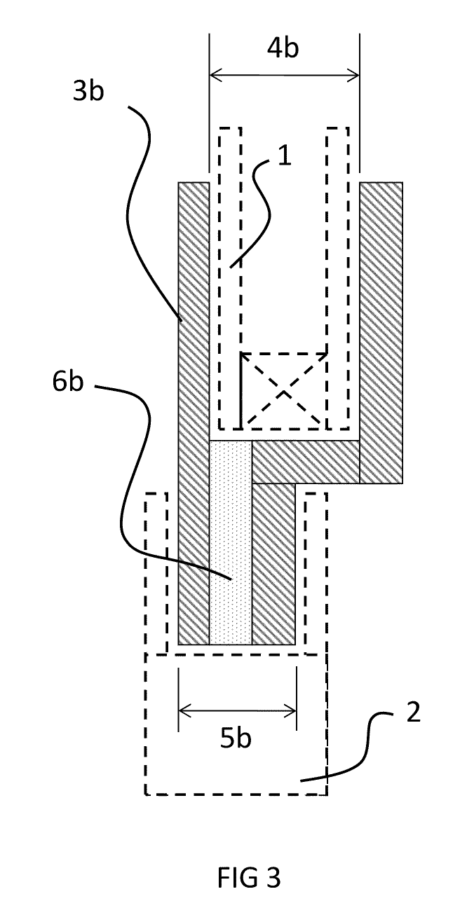

FIG. 3 shows a thermally broken adaptor 3b with metal legs (or flanges) that are joined with a connector (or flange), and formed of fiberglass or a polymeric material center layer, 6b, such as fiber reinforced polyester, polyurethane, or pultruded fiberglass reinforced polyurethane. The adaptor 3b mounts the glass structure 1 to the wall frame 2. The glass member 1 may be an IGU, such as a double or triple pane IGU. In an embodiment, the distance between opposing flanges 4b, of the adaptor 3b, may be greater than the distance 5b, provided by the wall frame 2. Distances 4b and 5b are termed the new and existing glazing pockets, respectively. In an embodiment, the glass structure may be an IGU, such as a double or triple pane IGU. The adaptor 3b comprises legs formed of a metallic material, such as aluminum or thermally broken aluminum. The center layer, 6b, comprises a mass of material of low thermal conductivity such as fiber reinforced polyester, polyurethane, or pultruded fiberglass reinforced polyurethane or other low conductivity materials. In an embodiment, low thermal conductivity may be less than about 1 Btu.in/hr.ft².F. For comparison, the thermal conductivity of aluminum is about 1000 Btu.in/hr.ft².F. Each flange of the adaptor 3b may be formed of a single piece or a plurality of pieces.

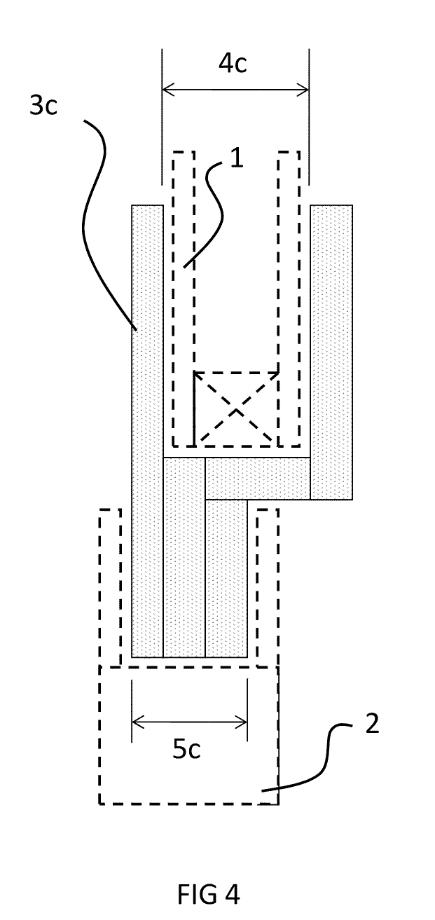

FIG. 4 shows an all composite adaptor 3c having legs (or arms) that are configured to secure the glass structure 1. The glass structure 1 may be an IGU, such as a double or triple pane IGU. In an embodiment, the distance between opposing flanges 4c, of the adaptor 3c, may be greater than the distance 5c, provided by the wall frame 2. Distances 4c and 5c are termed the new and existing glazing pockets, respectively. In an embodiment, the legs (or flanges) may be formed of low thermal conductivity materials such as fiberglass or a polymeric material, such as fiber reinforced polyester, polyurethane, or pultruded fiberglass reinforced polyurethane. In another embodiment, the flanges may be formed of fiberglass. The adaptor 3c comprises a mounting portion (or anchor portion) that is configured to mate the glass structure 1 to the window or wall frame 2. In the illustrated embodiment, the mounting portion of the adaptor 3c is defined by portions of the first flange and the second flange. The first flange and the second flange are joined by a third flange between the first and second flanges. The third flange may be formed of the same material as one or both of the first flange and the second flange. Each flange of the adaptor 3c may be formed of a single piece or a plurality of pieces.

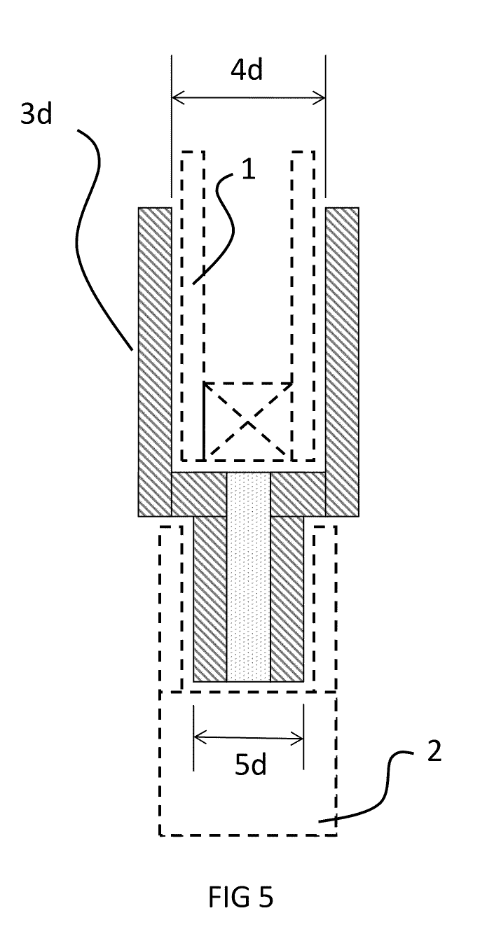

With reference to FIG. 5, a symmetric adaptor 3d is shown comprising a pair of flanges for securing a glass structure 1. The adaptor 3d is configured to mate the glass member 1 to the window or wall frame 2. The pair of flanges may be formed of a metallic material, such as aluminum. In the illustrated embodiment, the flanges are joined by a third flange that may be formed of a low thermal conductivity material such as fiberglass or a polymeric material, such as fiber reinforced polyester, polyurethane, or pultruded fiberglass reinforced polyurethane. In another embodiment, the third flange is formed of fiberglass. Each flange of the adaptor 3d may be formed of a single piece or a plurality of pieces.

In another aspect of the invention, a glass retrofitting system having an adaptor configured to mount a glass member to a wall or window frame is provided. The adaptor comprises a retaining member configured to align with a surface of the glass member and an anchor member configured to mount the adaptor to the wall or window frame. In an embodiment, the adaptor further comprises a connector or series of mechanical fasteners that joins the retaining member to the anchor member. In an embodiment, the connector may be angularly disposed in relation to the retaining member and the anchor member.

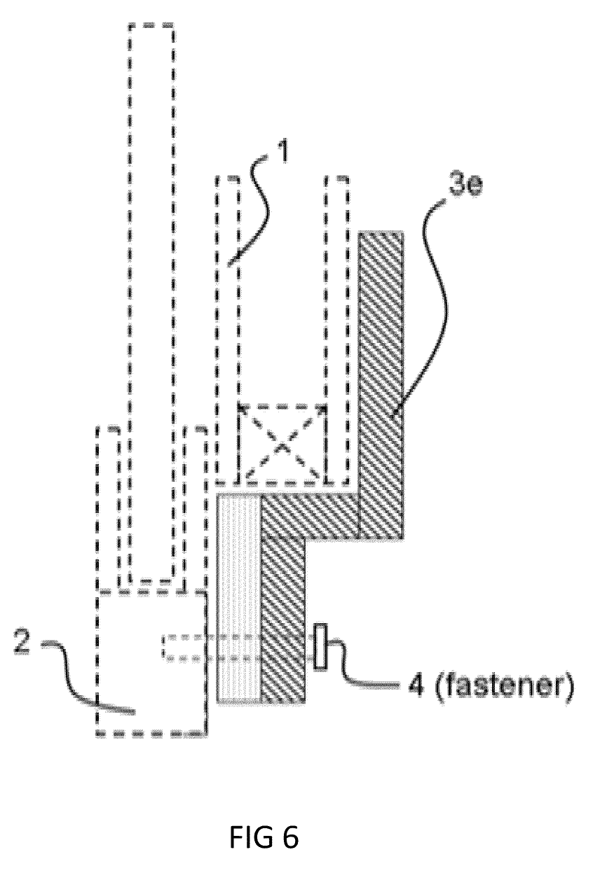

With reference to FIG. 6, an adaptor 3e (pressure plate) is shown comprising a flange (or leg) aligned with a surface of the glass structure 1 and an anchor portion mating the glass structure 1 to the window or wall frame 2, in accordance with an embodiment of the invention. The glass structure 1 may be an IGU. The adaptor 3e of the illustrated embodiment is a thermally broken pressure plate. The pressure plate 3e is mounted to the window or wall frame 2 with the aid of one or more fasteners 4, such as nails or screws or rivets. In an embodiment, the pressure plate 3e is formed of a metallic material, such as aluminum. In an embodiment, the pressure plate 3e comprises a flange between an anchor portion of the pressure plate 3e and the wall or window frame 2. The flange may be formed of fiberglass or a polymeric material, such as fiber reinforced polyester, polyurethane, or pultruded fiberglass reinforced polyurethane. The adaptor 3e may be formed of a single piece or a plurality of pieces. For instance, the adaptor 3e may be defined by three pieces.

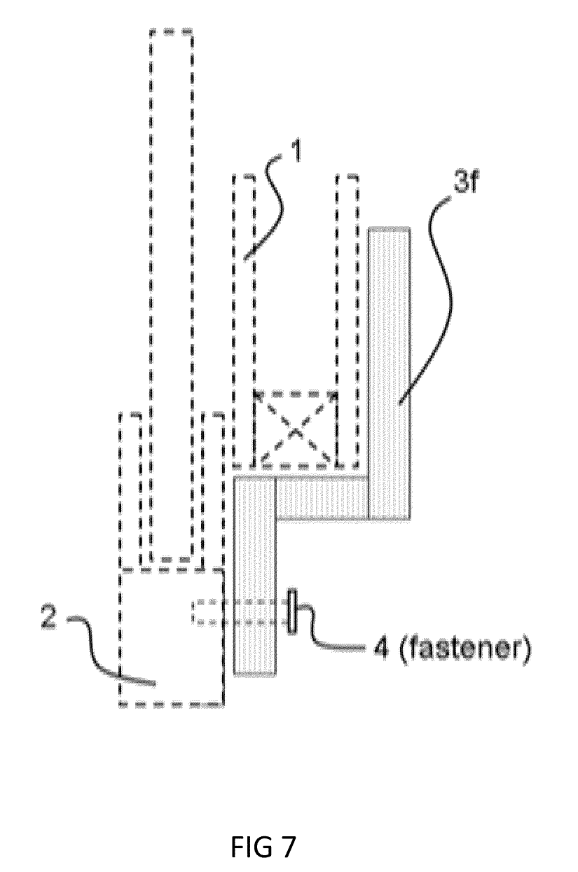

With reference to FIG. 7, an all composite adaptor 3f is shown for mating a glass structure 1 to a window or wall frame 2, in accordance with an embodiment of the invention. The adaptor 3f may be formed of a low thermal conductivity material such as fiberglass or a polymeric material, such as reinforced polyester, polyurethane, or pultruded fiberglass reinforced polyurethane. The adaptor 3f is secured to the window or wall frame 2 with the aid of one or more fasteners 4, such as nails or screws or rivets. The adaptor 3f may be formed of a single piece or a plurality of pieces.

In some embodiments, a method for retrofitting an existing window or wall frame structure with an upgraded insulated glass unit may be employed. The method may comprise steps of: selecting an existing window or wall frame for retrofit; selecting an adaptor such that a mating portion of the adaptor (or an anchor member of the adaptor) fits into an existing glazing pocket of the existing window or wall frame, where the existing glazing pocket is of a certain width; the adaptor forming a new glazing pocket suitable to hold the upgraded insulated glass unit; mounting or installing the upgraded insulated glass unit in the new glazing pocket formed by the adaptor. For example, in FIG. 1, a upgraded insulated glass unit 1 may be installed into window or wall frame 2 by utilizing adaptor 3. The adaptor may be formed as described in various embodiments herein.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. An retrofit adaptor for mounting an insulated glass unit (IGU), comprising:
a pair of retaining members for securing a glass structure of the IGU; and
a mating portion that provides mounting for the IGU, wherein the adaptor mounts the IGU to a window or a wall frame.

2. The retrofit adaptor of claim 1, wherein the adaptor circumscribes the IGU.

3. The retrofit adaptor of claim 1, wherein the adaptor is in contact with a left side and a right side of the IGU.

4. The retrofit adaptor of claim 1, wherein the pair of retaining members forms a new glazing pocket for the IGU and the mating portion fits into an existing glazing pocket in the window or wall frame.

5. A glass retrofitting system having an adaptor configured to mount a glass member to an existing window frame, the glass member having a first surface and a second surface, the adaptor comprising:
a first flange, wherein a first portion of the first flange is configured to align with the first surface, and wherein a second portion of the first flange is configured to mount the glass member to the existing window frame; and
a second flange, wherein a first portion of the second flange is configured to align with the second surface, and wherein a second portion of the second flange is configured to mount the glass member to the existing window frame.

6. The glass retrofitting system of claim 5, wherein the first flange and the second flange are symmetric.

7. The glass retrofitting system of claim 5, further comprising a sealing member for forming a seal between the first flange and the first surface and the second flange and the second surface.

8. The glass retrofitting system of claim 6, wherein the sealing member is a preformed gasket or a wet glazing material.

9. The glass retrofitting system of claim 5, wherein the first portion of the first flange is substantially parallel to the first portion of the second flange.

10. The glass retrofitting system of claim 5, wherein a distance between the first portion of the first flange and the first portion of the second flange is greater than a width of a glazing pocket of the existing window frame.

11. The glass retrofitting system of claim 5, wherein one or both of the first flange and the second flange are formed of a metallic material.

12. The glass retrofitting system of claim 5, wherein one or both of the first flange and the second flange are formed of fiberglass or a polymeric material.

13. The glass retrofitting system of claim 5, further comprising a third flange between the second portion of the first flange and the second portion of the second flange.

14. The glass retrofitting system of claim 13, wherein the third flange is formed of fiberglass or a low thermal conductivity polymeric material.

15. The glass retrofitting system of claim 5, wherein the first portion of the first flange is joined to the second portion of the first flange by a third portion that is angularly disposed in relation to the first portion of the first flange and the second portion of the first flange.

16. The glass retrofitting system of claim 5, wherein the distance between the first portion of the first flange and the first portion of the second flange is greater than the distance between the second portion of the first flange and the second portion of the second flange.

17. A glass retrofitting system having an adaptor configured to mount a glass member to a wall or window frame, the adaptor comprising:
a retaining member configured to align with a surface of the glass member; and
an anchor member configured to mount the adaptor to the wall or window frame.

18. The glass retrofitting system of claim 17, wherein the regaining member is formed of a single piece.

19. The glass retrofitting system of claim 17, wherein the retaining member is formed of a plurality of pieces.

20. The glass retrofitting system of claim 17, further comprising a connector that joins the retaining member to the anchor member.

21. The glass retrofitting system of claim 20, wherein the connector is formed of fiberglass or a polymeric material center layer.

22. The glass retrofitting system of claim 20, wherein the connector is formed of a low conductivity material.

23. The glass retrofitting system of claim 17, further comprising a plurality of mechanical fasteners that join the retaining member to the anchor member.
